(19) United States
(12) Patent Application Publication
(10) Pub. No.: US 2016/0155146 A1
(43) Pub. Date: Jun. 2, 2016

(54) Communication Management System for Sale and Distribution of Promotional Advertising

(71) Applicant: Trade Marketing and Promotion Group Inc., White Plains, NY (US)

(72) Inventors: Michael J. Valentino, Rye, NY (US); Richard Carthew, Yonkers, NY (US); Jill Hamilton, Bronx, NY (US)

(73) Assignee: Trade Marketing and Promotion Group Inc., White Plains, NY (US)

(21) Appl. No.: 14/955,568

(22) Filed: Dec. 1, 2015

Related U.S. Application Data
(60) Provisional application No. 62/086,043, filed on Dec. 1, 2014.

(51) Int. Cl. G06Q 30/02

(52) U.S. Cl. CPC G06Q 30/0255

(57) ABSTRACT

A system for facilitating the purchase and sale of advertising including a server with a non-transient computer readable storage medium. The server is in communication with at least one user device through a network, the user device being configured to receive user input. The server receives from the user device at least one Promotional Avail (PA) which includes a plurality of customizable elements of user input. The display of the user device presents a user interface, which is configured to present information related to the customizable elements in real time. The server is configured to cause to be presented proof-of-performance information to be presented on the user interface in response to a request.

### CROSS REFERENCE TO RELATED APPLICATION

The present application is a non-provisional of U.S. 62/086,043, entitled “Communication Management System for Sale and Distribution of Promotional Advertising,” and filed Dec. 1, 2014. The contents of U.S. 62/086,043 are hereby incorporated herein in their entirety.

### FIELD OF THE DISCLOSURE

The subject matter of the present disclosure generally relates to advertising and promotional transactions, and more particularly relates to automated platforms and methods by which those transactions can be facilitated.

### BACKGROUND OF THE DISCLOSURE

Advertising and promotions are important and even critical revenue sources for many businesses. Various systems have been proposed to facilitate mutually beneficial transactions between entities buying and selling advertisement placement and the execution of promotional services. For instance, U.S. Pat. No. 7,574,404 entitled “Method and System for Selecting and Purchasing Media Advertising” and filed Dec. 28, 2006, discloses a method and system for selecting and purchasing media advertising in a user/server environment. The system for purchasing media advertising operates through a Web site where a purchaser fills in a form to provide buying criteria and customer information. The server then processes the information in order to create a media advertising rate request. The rate request is sent to a media outlet, and the media outlet can then process the rate request and transmit it back to the server. Another example is U.S. Pat. No. 6,985,882, entitled “Method and System for Selling and Purchasing Media Advertising Over a Distributed Communication Network” and filed Feb. 5, 1999. The disclosed system of U.S. Pat. No. 6,985,882 provides an automated way of enabling and facilitating the marketing of available advertising time-slots from the inventory of sellers to buyers. It includes a database containing information relating to available advertising time slots provided by media providers. Purchasers of advertising time slots can search the database and make offers to the sellers for selected advertising opportunities. The system also allows buyers to input desired parameters of an advertising purchase, such as total budget, desired demographics, geographic region and time period. This particular disclosed system provides a means for buyers to select from an available database of available time slots for purchase. Notably however, it does not allow buyers/advertisers to send out requests for proposals. The disclosures of U.S. Pat. No. 7,574,404 and U.S. Pat. No. 6,985,882 are hereby incorporated by reference herein in their entirety.

### BRIEF SUMMARY

Disclosed are a system and method for aiding in the purchase and sale of advertising. In an embodiment, various user devices are associated with clients or agencies representing clients. The user devices have a user interface, which may be effected through an application or other program, which allows communication with a server. When a user desires to secure advertising, they interact with the user interface and enter a Promotional Avail (PA), which is characterized by a number of customizable elements. For instance, the user may select the target demographic, when the ad is to run, and their objectives in the ad campaign. In some instances, they may detail a contest to be conducted or a radio endorsement that is to be secured. The user interface presents information about these customizable elements in real time, allowing the user to selectively describe the desired advertising. The server is configured to cause to be presented on the user interface proof-of-performance information in response to a request. Users may dynamically view various metrics to track the effectiveness of campaigns.

### BRIEF DESCRIPTION OF THE DRAWINGS

FIG. 1 depicts the system architecture of an embodiment.

FIG. 2 depicts the user interface and options for adding custom elements to a PA.

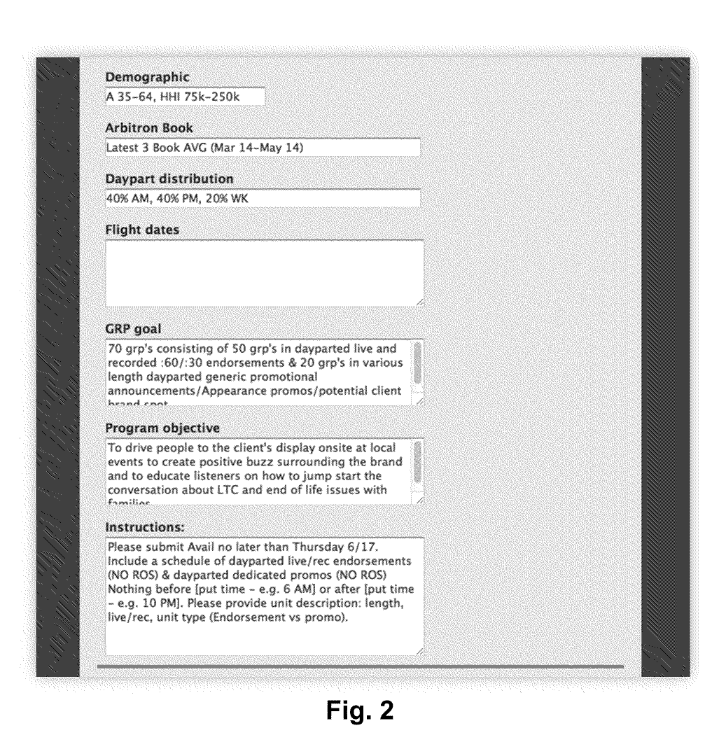

FIG. 3 depicts the user interface and the option to add custom elements to a PA.

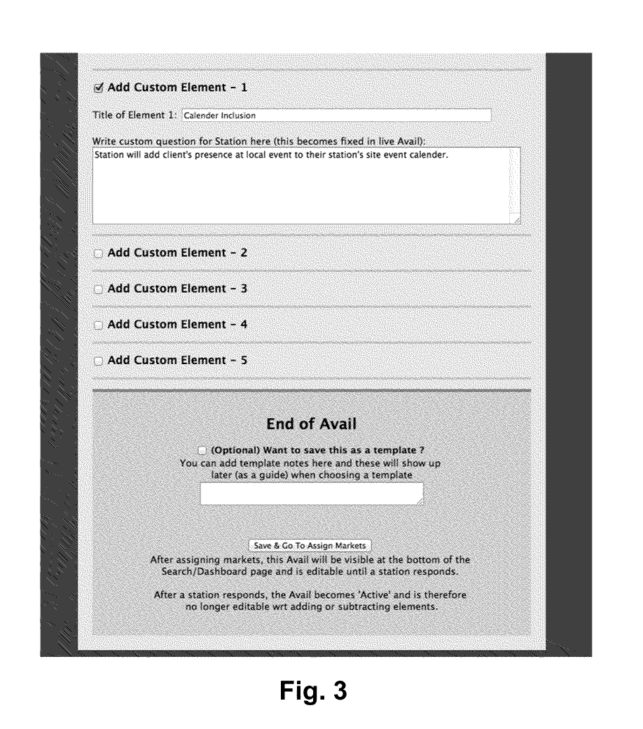

FIG. 4 depicts a market and budget summary as displayed in a user interface.

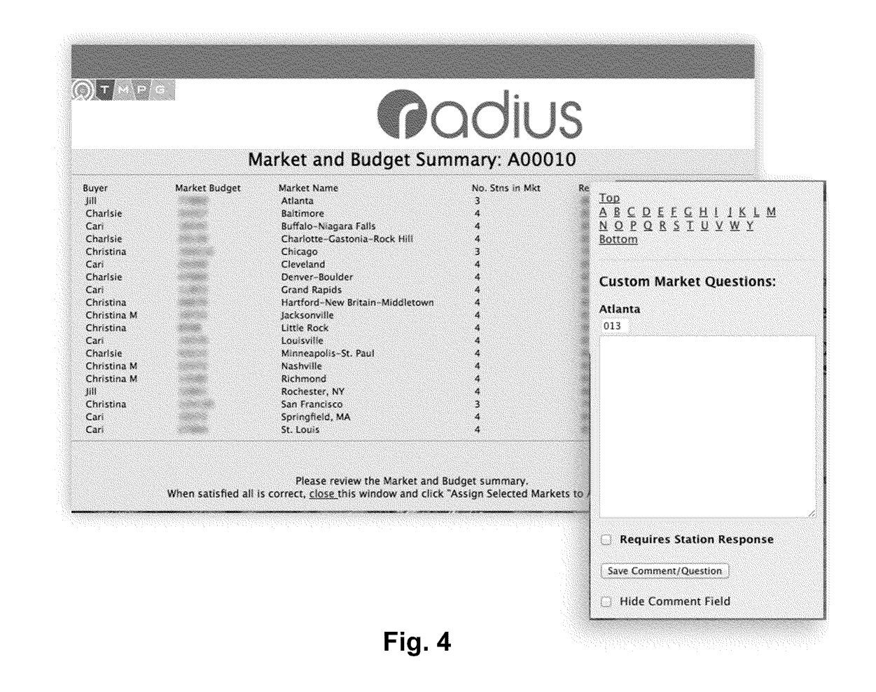

FIG. 5 depicts search results in a virtual dashboard of the user interface.

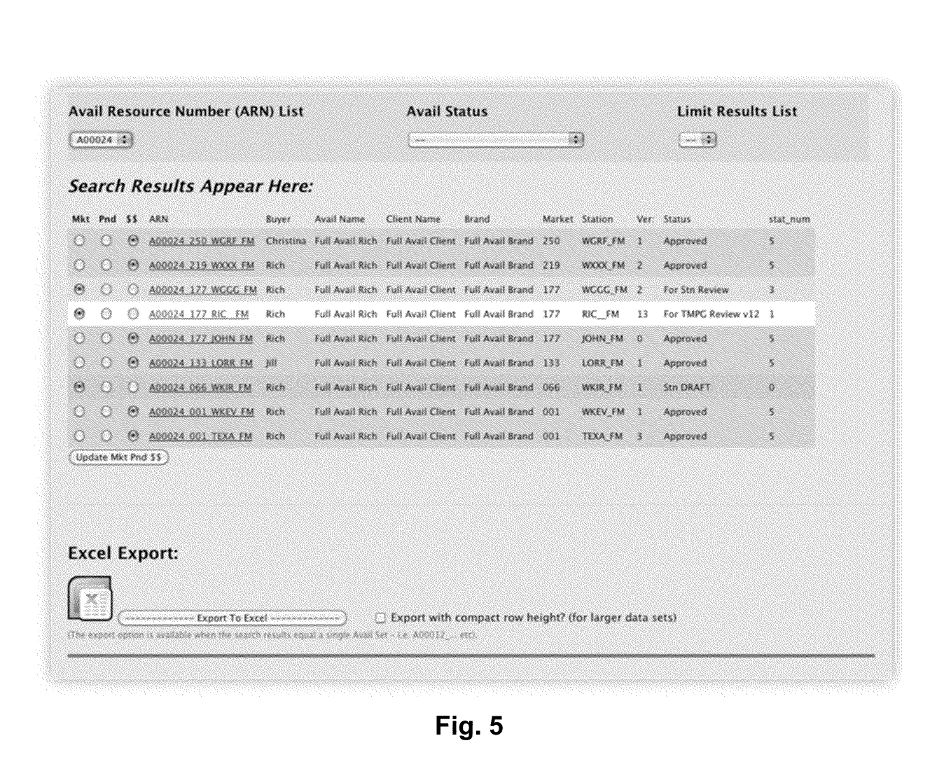

FIG. 6 depicts a data visualization report of Avail statuses.

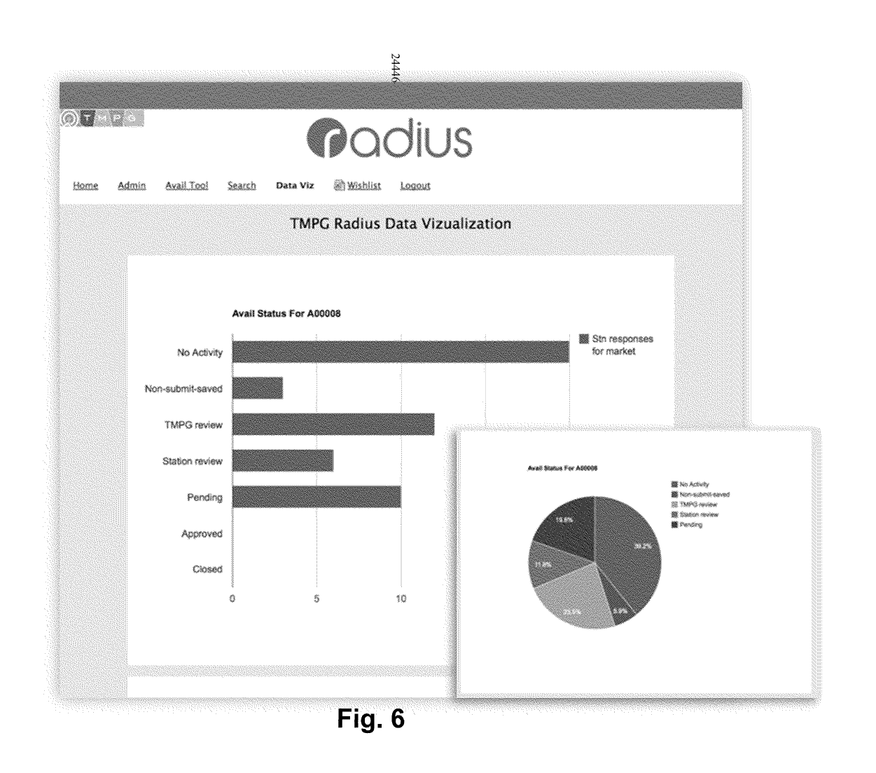

### DETAILED DESCRIPTION

Disclosed herein is a buyer-seller transactional system, referred to herein as “the Radius platform,” and a client-facing platform, referred to herein as “the Romeo platform.”

The Radius platform facilitates creation of Promotional Avails (PAs), as well as providing negotiation and confirmation functionality. It operates between a business or agency, which negotiates for advertising and promotions on its own behalf, or on the behalf of its clients, and the various providers of those advertising and promotional services, for example radio stations. PAs, as used within the present disclosure, refer to requests made to providers to submit proposals to deliver custom advertising and promotional campaigns, for instance spot commercials or custom promotions on a radio network.

The Romeo platform is a dynamic interface that can present to the client proof-of-performance information. This can include program recap reports, audio files, images, audio transcripts and video content. Romeo makes it possible for these forms of proof-of-performance to be delivered via the Internet to the business's clients on an on-demand basis.

Together these systems greatly enhance the efficiency of PA negotiations, Avail management both during and post-promotion, and increase client satisfaction by consistently delivering exacting promotional solutions.

The disclosed system operates in part by collecting, storing and disseminating large amounts of real-time information to businesses or their agencies that are negotiating advertising and promotions with vendors (primarily radio stations, but extending to other media outlets and specialized promotional vendors). The system also provides exported reports for use between the businesses' or agencies' internal Media and Account departments.

In many user embodiments, real-time information flow is achieved via exchange across HTML, Javascript (JSON & AJAX), PHP (server-side), and SQL & MySQL (Database) return pathways that are set up to allow the system web pages to display real-time changes made by all parties involved across the lifespan of the Avail.

As described herein the Radius platform additionally differentiates itself by giving the user various customization, tracking and reporting abilities in both an interactive and real time environment.

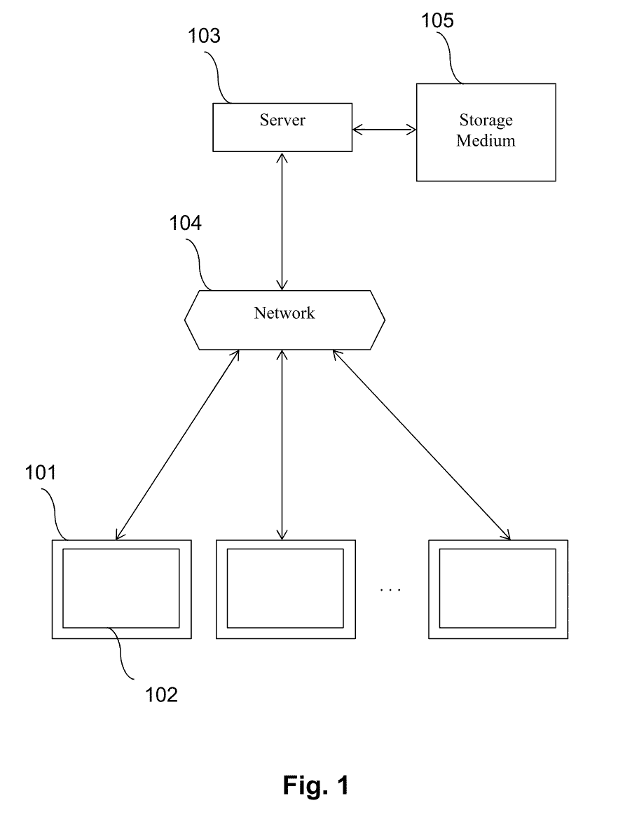

FIG. 1 depicts architecture for various components of an embodiment. Clients interact with the Radius and Romeo platforms through user devices 101, each of which has a display 102. User devices may be computers or any other suitable electronic device, such as smartphones, tablets etc. User devices 101 are connected to server 103 through network 104, such as the Internet, or, when via a mobile phone, a carrier's wireless network. The server stores information on non-transient computer readable storage medium 105, which may be local or remote from the server and be comprised of one or more hard drives or other suitable storage medium.

Now is described is the process by which a user can create a PA. In an embodiment user interface the user can select an icon corresponding to a tool for creating new Avails. The user may then select whether to create a new Avail from scratch or may select from a number of templates designed to ease the creation of common types of Avails. The custom elements the user may enter to describe the PA may include, without limitation:
An Avail name
A target demographic, for instance age 35-64 individuals with an income of between 75,000 and 250,000
An Arbitron brook (now known as Nielsen Audio) value, or the survey period used by Nielsen Audio to derive audience ratings which are used to measure and purchase media
Daypart distribution, which provides specific direction or goals to vendors referring to the percentage of GRPs that should be attributed to each on air day part such as AM Drive (AM), Midday (MD), PM Drive (PM), Evening (EV) or Weekend (WK)
Flight dates, or the calendar dates that media or promotional activity will be airing or occurring
A gross rating point (GRP) goal, including specifics as to the desired sources of GRPs.
A program objective, or what the client wishes to achieve through the campaign and optionally how those objectives might be achieved, for example “The client would like to create awareness of the new product and its benefits which will be achieved through on air DJ endorsements describing product attributes.”
Instructions, such as when to submit a bid and details about desired and undesired bid traits

The various fields used in the Radius avail system enable users to access broad categories of crucial planning data. That data is then used to design customized programs based on their unique goals and specifications.

The user may also add Avail elements, such as DJ endorsements along with a description of what is required of the DJ. Endorsement questions for stations may be included. Further, the PA may include a number of digital elements, including:
Banner & hyperlink
E-mail blast
Facebook
Twitter
Streaming
Website takeover
Mobile text messages
Video preroll
DJ video endorsement
DJ walk-on/Rovion
Rich media overlay

Such elements may be indicated in the Avail by any suitable means in the user interface, for instance by the selection of radio buttons or check boxes.

A user may also select to add as an element a contest, which may include one designed to drive traffic to a client, a station hosted web contest or a station hosted contest. Other elements that may be added include:
An interview with a client representative on a station
Added value traffic or weather sponsorships
Retail appearances at a client-selected location, along with details of how such appearances will occur
Local market events

One example could be a digital promotional drive that incentivizes consumers to attend a Local Market Event and enter into a contest specifically developed around the Market Event. A user may also indicate that an event is designed as a sampling event, indicating to a station to act appropriately. A user may optionally include custom instructions, requirements and questions with the PA to customize the PA to their desired preferences.

The user may also design their own custom elements by entering an element title and other details. In finalizing the PA, the user may select to save the PA as a template for use at a later date.

Once a PA has been created, the user may select individual markets in which the PA is to be fulfilled and dictate a gross budget. The user interface may optionally be configured to automatically calculate station budgets based on the gross budgets entered based on selected markets. Additionally, this information can be used to evaluate historical pricing and data trends. Once entered, a user may view an overview of the market and budget, including the various markets and the number of stations in those markets. This facilitates executive review of an advertising plan. A user may add custom questions specific to certain markets.

In another aspect of the disclosed system and method, a user is presented on the user interface a dashboard for managing Avails which includes a search tool. A user may search for specific Avails by filtering by client, brand, program, market, station, media buy, a resource number and/or status. The user may optionally limit the number of returned results, which can be color coded for ease of use. Upon receiving an overview of the results, the user may select to see additional details about specific Avails. An option to generate an excel spreadsheet is provided, allowing a user to easily export needed data.

A system administrator dashboard is provided for management of PAs entered by users. A administrator may make selections on stations' behalf.

Once received, stations may review and negotiate the Avails using the user interface, for instance by making counter offers to specifics provided in the PAs. Records of negotiations and agreements are automatically created to provide a detailed record of transactions.

In the user interface, the user may export various tables, for instance related to:
DJ Endorsements
Digital Elements
Contesting
Retail Appearances
Added Value Traffic
Interviews
Retail Events
Custom Elements

A user may view a Avail spot tracking grid of market and what advertising is being presented as well as associated details. Dynamic reports regarding various aspects of the Avails, such as status and progress, may be created for ease of management in the negotiation process.

Stations or other advertising platforms are provided their own logons to the user interface.

The system administrator dashboard may allow administrators to create, view and manage client extranets, send links to clients, and other functionality for managing the client experience.

In certain embodiments, the user is provided with an advertising client extranet plugin in addition to the Radius platform, which dynamically updates Avail promotional content produced by radio stations during the Avail program. Extranet material may include, without limitation, audio file DJ airchecks, event image galleries, screen shots of digital, promotion elements, Facebook posts, tweets, web grabs, copy points, station scheduling sheets, and excel planning documents (as web tables).

A preferred embodiment has several advantages over previous systems and methods. Customizable field-sets for custom Avail elements provides users with superior control over the advertising that is ultimately obtained. At the same time, the provision to the user of templates greatly aids in developing common Avail types. An option to export excel workbooks, internally and externally allows users to track progress. Furthermore, the provision of data filtering allows for identifying targeted result sets. Data in the system is propagated in real-time, meaning the user is always seeing current information. Access to the platform can be provided via a mobile device, allowing a user to create PAs virtually anywhere with an internet connection. Centralization and tracking of Avail negotiations and correspondence allows superior management of the Avail negotiation process.

Certain aspects of the above described embodiment are now explained in additional detail.

In certain embodiments, station profiles and Avails are collected and housed in a custom database system, where the values can be updated by the station and agency at any desired time. The station profile contains all the standard station information such as Name, Address, URL, Contacts etc, as well as additional data, such as Audience Demographics, Average income, AQH, Main music Genre, and their Market Location. Radius uses this data to reveal on each registered station's homepage all current and archived TMPG Avails that are/were assigned to them. As the profile is managed by the Station and used to provide access to the Radius system, the information is current and used in multiple features and functions in Radius, such as historical data trending.

In certain embodiments, a customized email notification system automatically generates and sends time-stamped email updates of Avail changes to all relevant parties for archival purposes. The email alerts staff and station representatives that an Avail has been reviewed and is ready for their counter-offer and serves as a delivery method for the Adobe PDF copy.

Automatic generation of Adobe PDF copies of the complete Avail are sent to each station and archived by the instituting business at each submission point across each Avail's lifespan. This PDF attachment is intended to engender increased confidence in the ongoing veracity of the Avail negotiation phase by 1) offering a visible and archivable set of records of each negotiation, particularly for those users who are not overly comfortable with operating in a highly digital system and 2) providing a tool for any subsequent disputes as to what was agreed to by each party and when.

Agency and station information that is populated into the dynamic relational database can be manipulated for the purposes of automatically carrying out rate calculations, as well as facilitating the distribution of complex data (optionally in Excel format) and trend reports between inter-agency departments semi-autonomously.

Vendors are offered a homepage in the user interface, which includes a tabulated summary of Avail statuses. It is here that the vendors can see both their active Avail statuses and their past Avails. For a certain time period vendors can review the final negotiated details of their historical Avails.

The Romeo platform client extranet enables the uploading of reports, files, airchecks and data for review. Automatic file naming for saving eases the classification and retrieval processes.

The Radius platform provides various advantages over previous systems. Whereas standard programmatic buying often involves a radio station posting their spot inventory and price for subsequent purchase by media agencies, the Radius's platform's core function is to facilitate an open negotiation with radio stations in order to develop individual and customized promotional Avails. In addition, these electronic Avails contain promotional elements that are specialized, such as Social Media activities, Endorsements, Contesting, Out Of Home (OOH) promotions, Sampling, Interviews, Added Value Traffic, Retail Appearances and open sections that can be customized per Avail for unique events. Below are brief descriptions and examples of the various promotional elements that can be added to any avail.
Social Media Activities—This may include the brand ambassador (station DJ who will endorse the client's product or service) or media vendor (radio station) using their social media outlets such as Facebook, Twitter and Instagram to promote the client's product or service or create a call to action on the client's behalf such as encouraging listeners to attend an event to enter a sweepstakes.
Endorsements—On air messaging by a station personality who will act on the brands behalf as an ambassador.
Contesting—A promotion designed to award prizes to consumers or listeners as well create awareness of a client's product or service.
Out of Home Promotions—this is not a term we use in radius so not sure if this is supposed to refer to events and appearances
In person activity designed to provide a brand with direct exposure to consumers. Such activity might include distributing samples of a product, featuring brand information at in market events or hosting station appearances at client chosen retail locations.
Sampling—The distribution of a client's actual product or coupons in order to encourage trial of that product.
Interview—Incorporating a question and answer of a client's spokesperson into messaging that will be featured as part of a client's promotion or program.
Added Value Traffic—Sponsorship of on air traffic or weather reports featured on a radio station.
Retail Appearances—A radio station hosting an on-site event a retail location in order to interact with consumers on a brands behalf.

This negotiation process is highly transparent between the operating business and the content distributor and both parties pass the Avail back and forth until a settlement is agreed upon. Once a settlement agreement is reached, the details of the Avail are exported from the Radius platform as Excel workbooks that list out all content outlets that have been ‘bought’ in each market that the promotion will run in. This data may be subsequently used for cross checking during the activation and post-promotion phases to ensure that all the agreed Avail content was carried out by each station.

In certain embodiments, the Romeo platform is a web based extranet linked to the Radius platform which is dynamically updated for the client with new Avail content when it is saved to its media server. As the promotional elements in the Avail are carried out, they are captured digitally and populate the Romeo platform plugin and become available for the client to view and verify the content. A custom media extranet is optionally created for each Avail client in tandem with the promotional Avail that the content outlets submit on. This is done via a user interface that offers a selection of elements that can be included or excluded from each client extranet. Once the selections are made and all the client details are entered, the Romeo platform automatically creates all the extranet's directories, files and links on its media server and returns a unique client link (to the extranet), username and password.

In some embodiments, the Romeo platform includes an Excel workbook containing planning schedules and other information to be saved into a directory and which is dynamically uploaded into the Romeo platform and parsed into a web table for the client to view. In certain embodiments, image galleries and thumbnails of promotional events are automatically generated. Optionally, embodiments can include an embedded audio-video (AV) player for reviewing audio files with DJ endorsement air-checks and also video files. The content that appears in here is often cross-referenced with the Excel Element Reports exported from Radius, for example if a media provider agrees to provide Digital or Social Elements within the Avail negotiation phase.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A system for facilitating the purchase and sale of advertising, comprising:
a server having a non-transient computer readable storage medium;
wherein the server is in communication through a network with at least one user device having a display and being configured to receive user input;
wherein presented on the display is a user interface;
the server being configured to receive from the user device at least one Promotional Avail (PA) including a plurality of customizable elements of user input;
the user interface being configured to present information relating to the customizable elements in real time;
wherein the PA is stored on the computer readable storage medium; and
the server being further configured to cause to be presented on the user interface proof-of-performance information in response to a request.

2. The system of claim 1 wherein the user interface is configured to present an option for entry of the Promotional Avail according to a template.

3. The system of claim 1 wherein the user interface is configured to present a customizable dashboard including information about the PA.

4. The system of claim 1 wherein the proof-of-performance information includes at least one of a recap report, an audio file, an image, an audio transcript and a video.

5. The system of claim 4 wherein the server is configured to supply the proof-of-performance information on an on-demand basis.

6. The system of claim 1 wherein the customizable elements include at least one of targeted demographic, survey period, daypart distribution, and gross rating point (GRP) goal.

7. The system of claim 1 wherein the customizable elements include at least one digital element.

8. The system of claim 1 wherein the customizable elements include at least one of a DJ endorsement and a contest.

9. A method of facilitating the purchase and sale of advertising, comprising the steps of:
providing a server having a non-transient computer readable storage medium;
wherein the server is in communication through a network with at least one user device having a display and being configured to receive user input;
wherein presented on the display is a user interface;
receiving from the user device at least one Promotional Avail (PA) including a plurality of customizable elements of user input;
storing the PA is stored on the computer readable storage medium; and
presenting on the user interface proof-of-performance information in response to a request.

10. The method of claim 9 wherein the customizable elements of user input are received according to a template.

11. The method of claim 9 wherein the user interface is configured to present a customizable dashboard including information about the PA.

12. The method of claim 9 wherein the proof-of-performance information includes at least one of a recap report, an audio file, an image, an audio transcript and a video.

13. The method of claim 12 wherein the server is configured to supply the proof-of-performance information on an on-demand basis.

14. The method of claim 9 wherein the customizable elements include at least one of targeted demographic, survey period, daypart distribution, and gross rating point (GRP) goal.

15. The method of claim 9 wherein the customizable elements include at least one digital element.

16. The method of claim 9 wherein the customizable elements include at least one of a DJ endorsement and a contest.
